(19) United States
(12) Patent Application Publication
(10) Pub. No.: US 2026/0346472 A1
(43) Pub. Date: Nov. 5, 2026

(54) ARTICLE MOVING DEVICE AND CONTROL METHOD FOR SAME

(71) Applicant: TELEXISTENCE INC., Tokyo (JP)

(72) Inventors: Pavel SAVKIN, Tokyo (JP); Yukitoshi MINAMI SHIGUEMATSU, Tokyo (JP)

(73) Assignee: TELEXISTENCE INC., Tokyo (JP)

(21) Appl. No.: 19/118,924

(22) PCT Filed: Oct. 4, 2023
(86) PCT No.: PCT/JP2023/036275

§ 371 Date: Apr. 7, 2025

(30) Foreign Application Priority Data
Oct. 14, 2022 (JP) 2022-165852
Jul. 20, 2023 (JP) 2023-118706

(51) Int. Cl. B25J 13/08; B25J 9/16

(52) U.S. Cl. CPC B25J 13/089; B25J 9/1671; B25J 9/1687

(57) ABSTRACT

According to one embodiment of the present disclosure, a product transfer apparatus including an arm unit having a holder unit, an acquisition unit configured to obtain surrounding environment information, and a processor as a control unit is provided. The processor is configured to perform allowing the acquisition unit to obtain the surrounding environment information, generating a virtual world including an object in the real world, based on the surrounding environment information, in the virtual world, assigning annotation information including attribute information of the object and information regarding a position, a posture and a dimension of the object, to the object, accepting a first input designating a product to be moved, and a second input designating a position or an area of a movement destination of the product, for the object present in the virtual world, and in the real world, allowing the holder unit and the arm unit to perform operation of moving the designated product to the designated position or the designated area, based on the first input and the second input.

### TECHNICAL FIELD

The present invention relates to a product transfer apparatus and a method of controlling the product transfer apparatus.

### BACKGROUND

Conventionally, in logistics warehouses which are base stations for transporting products, by using a product transfer apparatus equipped with a robot arm, operation of transferring products such as packed goods, etc. loaded on a pallet onto a cart, and moving the products successively onto a belt conveyor have been performed. In order to allow the product transfer apparatus to properly perform operations for products packed in packing boxes, pallets, carts, belt conveyers, etc. (hereinafter, these items are collectively referred to as the “objects”), it is preferable for the product transfer apparatus to recognize the attributes, the positions, the postures, etc. of these objects.

The international patent publication WO2020/218533 proposes a method of assigning attribute information to an object. The method includes generating a virtual world reproducing an environment in the real world, acquiring a model corresponding to the object in the virtual world to which the attribute information is to be assigned, and assigning attribute information including information relating to at least one part of the model to the model.

Further, the international patent publication WO2020/235539 propose a method of identifying the position and the posture of an object. The method includes generating a virtual world including a display of the object in the real world, displaying, in the virtual world, a model corresponding to the object, superimposing, in the virtual world, the model on the object, and identifying the position and posture of the object by comparing the object and the model.

### SUMMARY

However, neither the international patent publication WO2020/218533 nor the internal patent publication WO2020/235539 goes so far as to provide means for assigning attribute information and information about the position and the posture to the object collectively in a series of operations.

Further, even assuming that it is possible to obtain information about the attributes, the positions, and the postures of objects such as products, pallets, carts, and belt conveyors which are present around the product transfer apparatus in logistics warehouses, etc., by the methods disclosed in the international patent publication WO2020/218533 and the internal patent publication WO2020/235539, neither the international patent publication WO2020/218533 nor the internal patent publication WO2020/235539 goes so far as to provide means of determining whether or not these objects which are present around the product transfer apparatus are positioned in a manner which enables operation of moving products (e.g., transferring products on a pallet to a cart) to be performed by the product transfer apparatus.

At workplaces in logistics warehouses, etc., position layout of the product transfer apparatus and objects placed around the product transfer apparatus is not fixed, and the positions of these objects may be changed as necessary depending on the operation of moving the objects. In the case where the positions of the product transfer apparatus and various objects around the product transfer apparatus are changed in such a manner, if these objects after the change are not placed at positions where the operation of moving the products can be performed by the product transfer apparatus, it will not be possible to perform operation of moving the products by the product transfer apparatus.

An object according to one aspect of the present disclosure is to provide means which makes it possible to easily assign annotation information regarding attributes, the position/posture, and the dimensions of an object placed around a product transfer apparatus, to the object. Further, an object according to another aspect of the present disclosure is to provide means which makes it possible to determine whether or not the position layout of an object is position layout where operation of moving the product by a product transfer apparatus can be performed.

According to one aspect of the present disclosure, a product transfer apparatus configured to move a product is provided. The product transfer apparatus includes an arm unit having a holder unit configured to hold the product, an acquisition unit configured to obtain surrounding environment information the product transfer apparatus, and a control unit configured to control operation of the holder unit, the arm unit, and the acquisition unit. The control unit is configured to perform allowing the acquisition unit to obtain the surrounding environment information of the product transfer apparatus in a real world, generating a virtual world including an object present around the product transfer apparatus in the real world, based on the surrounding environment information, in the virtual world, assigning annotation information including attribute information of the object and information regarding a position, a posture and a dimension of the object, to the object, accepting a first input designating a product to be moved, and a second input designating a position or an area of a movement destination of the product, for the object present in the virtual world, and in the real world, allowing the holder unit and the arm unit to perform operation of moving the designated product to the designated position or the designated area, based on the first input and the second input.

According to another aspect of the present disclosure, the control unit is configured to further perform determining whether or not the object designated in the first input and the second input is present within an accessible range of the product transfer apparatus. The allowing the holder unit and the arm unit to perform operation of moving the designated product to the designated position or the designated area is performed in the case where the designated object is present within the accessible range.

Other features and advantages of the present disclosure can be understood from the following description and the accompanying drawings which are given in an illustrative and non-comprehensive manner.

According to one aspect of the present disclosure, means which makes it possible to easily assign annotation information regarding attributes, the position/posture, and the dimensions of an objects placed around the product transfer apparatus, to the object, is provided. Further, according to another aspect of the present disclosure, means which makes it possible to determine whether or not the position layout of the objects is position layout where operation of moving the product by the product transfer apparatus can be performed.

### BRIEF DESCRIPTION OF THE DRAWINGS

FIG. 1 is a plan view schematically showing a product transfer apparatus and objects placed around the product transfer apparatus in a warehouse;

FIG. 2 is a front view schematically showing the product transfer apparatus and the objects in the warehouse;

FIG. 3 is a side view schematically showing structure of the product transfer apparatus according to the present embodiment;

FIG. 4 is a block diagram showing structure of the product transfer apparatus according to the present embodiment;

FIG. 5 is a view showing one example of a UI screen for selecting types of objects displayed on a display unit;

FIG. 6 is a view showing a state where the position, the posture, and the dimensions of a model are changed in a virtual world displayed on a display unit, in accordance with an operation input from an operation unit by a user;

FIG. 7 is a flow chart showing operation of moving a product by the product transfer apparatus;

FIG. 8 is a view illustrating first operation and second operation in step S11 shown in FIG. 7;

FIG. 9 is a view showing an example of a state where a position or an area of a movement destination of the product are designated;

FIG. 10 is a view showing a modification example of the product transfer apparatus according to the present embodiment; and

FIG. 11 is a view showing another modification example of the product transfer apparatus according to the present embodiment.

### DETAILED DESCRIPTION

Hereinafter, an embodiment of the present disclosure will be described with reference to the drawings.

### Layout Structure of Logistics Warehouse

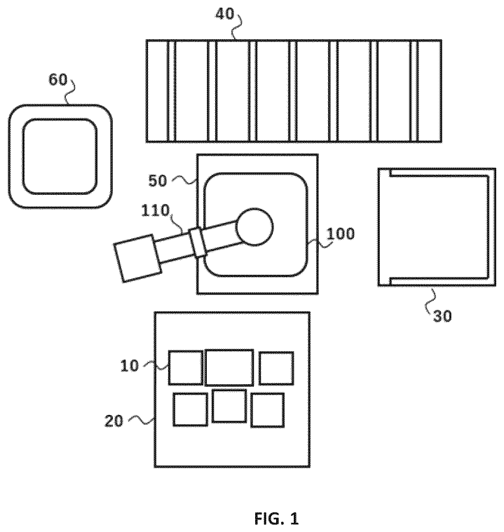

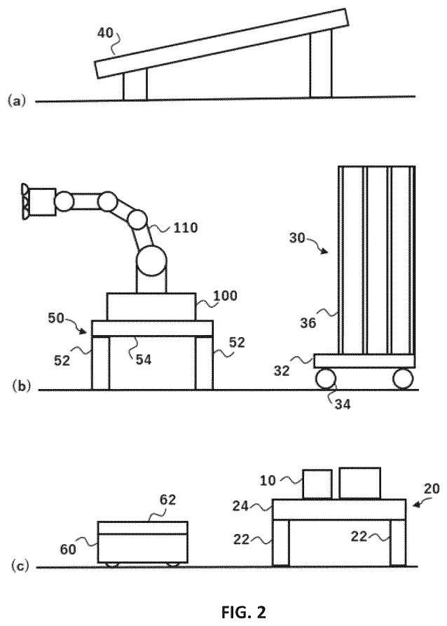

Firstly, layout structure of a logistics warehouse (hereinafter also simply referred to as the “warehouse”) will be described. FIG. 1 is a plan view schematically showing a product transfer apparatus and objects placed around the product transfer apparatus (items such as goods packed in a packing box, a pallet, a cart, a belt conveyer, etc.) in the warehouse. FIG. 2 is a front view schematically showing the product transfer apparatus and the objects in the warehouse.

For example, as shown in FIGS. 1 and 2, in the warehouse, a product transfer apparatus 100 having a robot arm 110, a pallet 20 loaded with products 10 such as goods packed in a packing box, a cart 30 used by a worker to transport the products 10, and a belt conveyor 40 which transports the products 10 placed on a rotating belt are placed. The pallet 20, the cart 30, and the belt conveyor 40 are placed within an area of distance which allows the robot arm 110 of the product transfer apparatus 100 to perform operation of moving a product.

The product transfer apparatus 100 is provided fixedly on a placement table 50. The placement table 50 includes two side surfaces 52 and one upper surface 54, and forms a space between the upper surface 54 and the floor surface, etc. where the automatic guided vehicle (AGV) 60 described later can enter the space.

The pallet 20 includes two side surfaces 22 and one upper surface 24, and forms a space between the upper surface 24 and the floor surface, etc. where the automatic guided vehicle (AGV) 60 described later can enter the space.

The cart 30 includes a loading section 32 on which the products 10 are loaded, a plurality of casters 34 provided below the loading section 32, and protection fences 36 provided above the loading section 32. Since the cart 30 is equipped with a caster 34, the worker can push the cart 30 to move the cart 30 inside the warehouse. The protection fences 36 are provided on three sides of the loading section 32 to prevent the products 10 loaded on the loading section 32 from, e.g., collapsing and falling off the cart 30.

The placement table 50 carrying the product transfer apparatus 100 and the pallet 20 can be transported by the automatic guided vehicle 60 (hereinafter referred to as the AGV (Automatic Guided Vehicle)) inside the warehouse. The AGV 60 can move autonomously by sensing the surrounding environment, or the AVG 60 can move in response to remote control by the user. The AGV 60 has a hydraulic system which moves upper part 62 of the AGV 60 in the vertical direction. After the AGV 60 enters under the pallet 20 or the placement table 50 having a U-shape, in a state where the upper part 62 of the AVG 60 is lowered to decrease the height of the AGV 60, the hydraulic system is activated to elevate the upper part 62 to raise the pallet 20 or the placement table 50 to a height spaced from a floor surface, and in the state where the pallet 20 or the placement table 50 is mounted on the AVG 60, transports the pallet 20 or the placement table 50 to another position in the warehouse. After the AGV 60 moves to a transport position, the upper part 62 of the AGV 60 is lowered to ground the pallet 20 or the placement table 50 to the floor surface to finish the transportation, and leaves from a position below the pallet 20 or the placement table 50. Further, the AGV 60 can also tow the cart 30 to move the cart 30 inside the warehouse.

### Structure of Product Transfer Apparatus 100

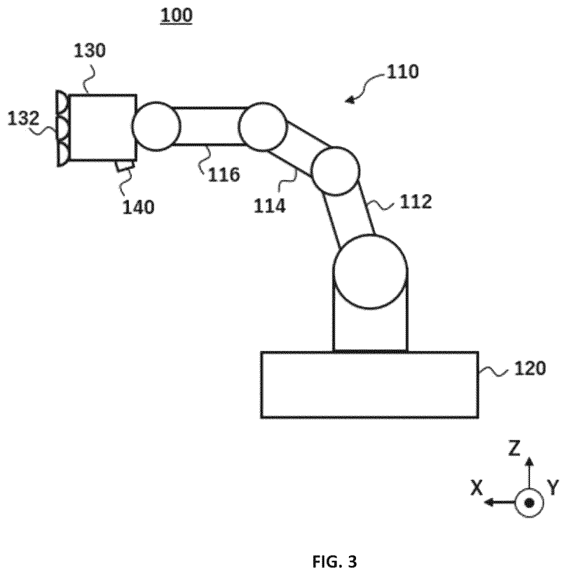

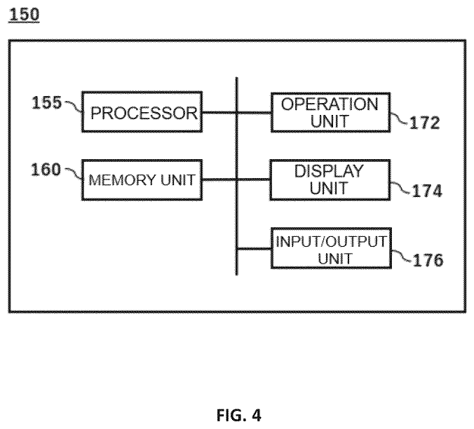

Next, the product transfer apparatus 100 according to the present embodiment will be described with reference to FIGS. 1 to 4. FIG. 3 is a side view schematically showing structure of the product transfer apparatus 100 according to the present embodiment. FIG. 4 is a block diagram showing structure of the product transfer apparatus 100 according to the present embodiment.

The product transfer apparatus 100 includes an arm unit 110, a base unit 120 for fixedly supporting the arm unit 110, a holder unit 130 provided at a front end of the arm unit 110, a camera 140 provided on the holder unit 130, and a control device 150 engaged in the process of controlling the entire product transfer apparatus 100, including operation control of the arm unit 110 and the holder unit 130, and each of processes described later. The product transfer apparatus 100 can function as a cargo handling robot which performs operation of holding the product 10, and moving the product 10 to another position (hereinafter also referred to the “Pick and Place (PnP) operation”). For example, the product transfer apparatus 100 transfers products 10 such as packed goods loaded on the pallet 20 in the logistics warehouse onto the cart 30 or onto the belt conveyor 40.

The arm unit 20 includes a plurality of link members 112, 113, 116. The plurality of link members 112, 113, 116 form a multi-joint robot arm. For example, the multi-joint robot arm may be a 6-axis arm with degrees of freedom in a straight direction along each of the X, Y, and Z axis directions, and with degrees of freedom in each of the directions about the X, Y, and Z axes. The multi-joint robot arm may have any other mechanism, such as an orthogonal coordinate system robot arm, a polar coordinate system robot arm, a cylindrical coordinate system robot arm, or a SCARA robot arm. A proximal end of the arm unit 20 is placed in a manner that the proximal end of the arm unit 110 is fixed to the placement table 50 described above. By moving the respective link members 112, 113, 116, it is possible to move the holder unit 130 within a range of the distance reachable by the arm unit 110.

For example, the holder unit 130 is a suction gripper, and as shown in FIG. 3, includes a plurality of suction caps 132 for holding a product. The holder unit 130 includes suction means (not shown) such as a vacuum pump, and sucks the air from an air intake port opened to the inside of each of the suction cups 132. In this manner, it is possible to hold the surface of the product by the plurality of suction cups 132.

For example, the camera 140 is provided on a side surface adjacent a surface where the suction cups 132 of the holder unit 130 are provided. The camera 140 is used to obtain environment information around the product transfer apparatus 100 in an area below the arm unit 110, from the front end of the arm unit 110. For example, the camera 140 may have an image capture element and a depth sensor. The image capture element generates a capture image (RGB image in one example) in which pixels are arranged in two dimensions. The depth sensor is a distance detection device for generating distance data. The depth sensor is not limited to a certain type as long as the depth sensor is capable of obtaining data of the distance to the target object. For example, the depth sensor may use a stereo lens system or a LiDAR (Light Detection and Ranging) system. For example, the depth sensor may generate Depth images. For example, the camera 140 may utilize an ultrasonic element to obtain the distance data.

### Structure of Control Device 150

As shown in FIG. 4, the control device 150 has a processor 155, a memory unit 160, an operation unit 172, a display unit 174, and an input/output unit 176. In FIG. 4, though the control device 150 is drawn as a single element, the control device 150 does not necessarily have to be a physically single element, but may be made up of a plurality of elements that are physically separated from each other.

The operation unit 172 is a device for accepting inputs from the user. The operation unit 172 may be made up of devices for providing inputs to a computer such as a tracker capable of tracking the position and the posture using infrared rays, etc. and having a trigger button, etc., and a remote controller referred to as the VR controller, etc., in addition to a keyboard, a mouse, a touch panel. The operation unit 172 may have an audio input device such as a microphone. Further, the operation unit 172 may have a gesture input device which recognizes and identifies user's movement through image recognition.

The display unit 174 is a display device for displaying a display screen generated by the processor 155. For example, the display unit 174 may be a flat display device such as liquid crystal display or an organic EL display. Alternatively, the display unit 174 may be a head mount display (HMD). The input/output unit 176 is connected to the arm unit 110, the holder unit 130, and the camera 140 of the product transfer apparatus 100 by wired communication or wireless communication, and outputs control signals to, and inputs obtained information from these components.

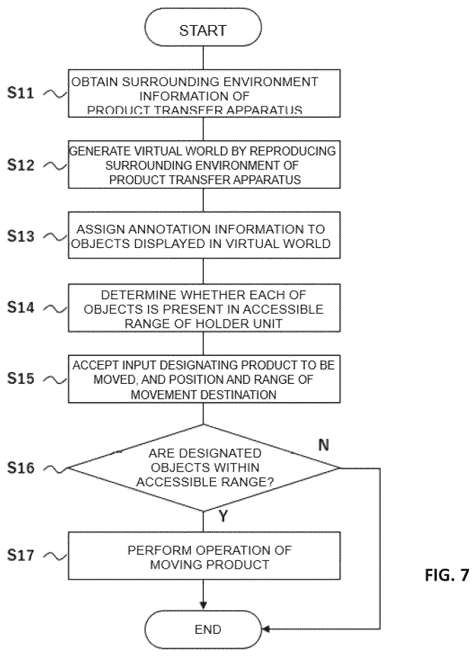

The memory unit 160 includes a transitory or non-transitory storage medium such as a ROM (Read Only Memory), a RAM (Random Access Memory), a HDD (Hard Disk Drive), or a SSD (Solid State Drive). The memory unit stores computer programs executed by the processor 155. The computer programs stored in the memory unit 160 includes an instruction for carrying out a method of controlling the product transfer apparatus 100 by the processor 155, described later with reference to FIG. 7, etc.

The memory unit 160 further stores, at least temporarily, information received from the camera 140 and various items of data (including interim data) generated by processing operations by the processor 155.

For example, the processor 155 is made up of one or two or more CPUs (Central Processing Unit). The processor 155 executes computer programs stored in the memory unit 160 to mainly perform processing based on inputs by the user through the operation unit 172, input/output control of the input/output unit 176, display control of the display unit 174, etc. In particular, the processor 155 generates one or a plurality of control signals to operate each of drive units (not shown) of the arm unit 110 and the holder unit 130 and the camera 140 based on the user input provided by the user through the operation unit 172.

Further, the processor 155 is configured to generate an UI (user interface) screen presented to the user, and display the UI screen on the display unit 174. For example, the UI screen (not shown) includes a selection button display for displaying a plurality of options to the user. Further, the processor 155 generates an image or a video of the virtual world (simulation space) based on an image or a video of the real world, of the environment surrounding the product transfer apparatus 100, obtained by the camera 140 of the product transfer apparatus 100, and displays the image or the video of the virtual world on the display unit 174. At the time of generating the image or the video of the virtual world based on the image or the video of the real world, the processor 155 establishes a correlation between the real world and the virtual world by, for example, correlating the coordinate system of the real world with the coordinate system of the virtual world. Further, the image or the video of the virtual world (simulation space) and the image or the video of the real world may be displayed on the display unit 174 at the same time.

The image or the video of the virtual world (simulation space) generated based on the image or the video of the real world of the surrounding environment of the product transfer apparatus 100 also include objects (the products 10, the pallet 20, the cart 30, the belt conveyor 40, etc.) which are present in the environment surrounding the product transfer apparatus 100. At the time of generating the image or the video of the virtual world based on the image or the video of the real world, the processor 155 establishes a correlation between the real world and the virtual world by, for example, correlating the coordinate system of the real world with the coordinate system of the virtual world. In this manner, as described later in detail, it becomes possible to associate the user's operation in the virtual world with operation of the product of the product transfer apparatus 100 in the real world.

Further, the processor 155 of the control device 150 is configured to generate a model corresponding to an object included in the image or the video in the virtual world (simulation space), and performs the process of assigning attribute information of the object to the generated model.

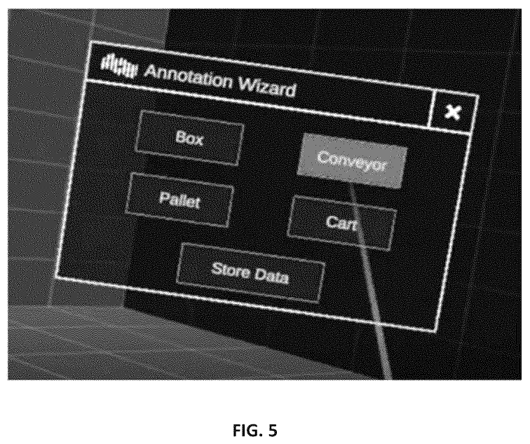

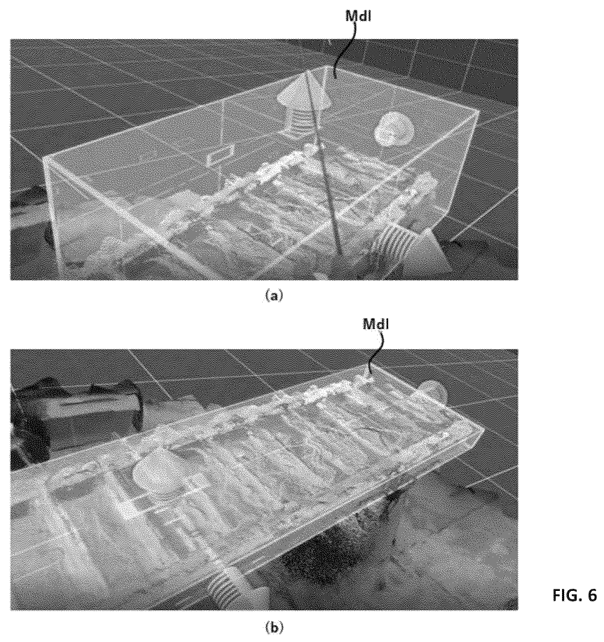

FIGS. 5 and 6 are views illustrating the processing operation of the processor 155 of the control device 150 to assign the annotation information to the object through the model corresponding to the object.

When the processor 155 of the control device 150 accepts predetermined operation (e.g., pressing of a predetermined button of the controller), the processor 155 displays the UI screen for allowing the user to select a type of an object as a target for which the model should be generated. FIG. 5 shows an example of an UI screen for selecting the type of an object displayed on the display unit 174 by the processor 155. In the UI screen shown in FIG. 5, as a type of the selectable objects, “Box (packed goods), “Conveyor (belt conveyor), “Pallet”, and “Cart” are presented, and a state where the user is pointing, and selecting the “Conveyor (belt conveyor)” using the operation unit 172 is displayed. For example, the selection operation of the object type on the UI screen can be performed by pointing a destination of an indication line which moves in unison with the operation unit 172 to the position of an option of the object type to be selected, and then pressing a predetermined button of the operation unit 172. By accepting the selection operation of the object type in this manner, the processor 155 obtains the attribute of the selected object type (in the above example, Conveyor (belt conveyor) as an attribute) as attribute information to be associated with the model to be generated as described below next.

After accepting the selection of the object type by the operation unit 172, the processor 155 then displays the virtual world (simulation space) of the environment surrounding the product transfer apparatus 100 on the display unit 174. At this time, the display unit 174 shows a model for designating the contour shape, the posture and the dimensions of the selected object (in the above example, the Conveyor (belt conveyor)) in the same virtual world (simulation space). For example, the model has a rectangular parallelepiped shape.

Then, the processor 155 changes the position, the dimensions, and the posture of the model in the simulation space displayed on the display unit 174 in response to the user's operation input from the operation unit 172. The operation input by operation unit 172 can be performed, for example, by pointing the model Mdl and pressing a predetermined button of the controller to drag the model Mdl and move the model Mdl to the desired position and posture, and by pointing the model Mdl and pressing a predetermined button of the controller to move any of the edges or vertices of the model Mdl, as in the manner of changing the dimensions of a so-called bounding box.

FIG. 6 is a view showing a state where the position, the posture, and the dimensions of a model are changed in a simulation space displayed on the display unit 174, in accordance with an operation input from the operation unit 172 by a user.

FIG. 6(a) is a view showing a scene where the position, the dimensions, and the posture of the model are changed in accordance with the operation input from the operation unit 172. In FIG. 6(a), a model Mdl displayed in the simulation space is roughly in alignment with the position of a scanned image of the conveyor displayed in the same simulation space. From this state, when the position, the posture and the dimensions of the sides of the model Mdl are further adjusted in response to the operation input from the operation unit 172 by the user, as shown in FIG. 6(b), the contour of the model Mdl roughly matches the outer contour of the conveyor in the scanned image. As a result, the generation of the model Mdl is completed.

When the processor 155 accepts an input operation for model generation (e.g., pressing of a predetermined button of the controller) at the operation unit 172 by the user, the position, the posture, and the dimension of each side of the model Mdl designated at the time are obtained as the position, the posture, and the dimension of each side of the corresponding object (in this example, a belt conveyor). The data of the model Mdl generated in this manner is stored in the memory unit 160 of the control device 150.

By a series of processes as described above, the processor 155 assigns annotation information, including attribute information and information about the position, the posture and the dimensions (dimensions of the length, the width, and the height), to the corresponding object, through the model Mdl in the coordinate system of the virtual world (simulation space). Based on the annotation information assigned in this manner, the processor 155 can calculate and recognize the position, the posture and the dimensions of the corresponding object (belt conveyor) in the coordinate system of the real world.

Further, the processor 155 is configured to detect objects present in the image based on the image captured by the camera 140, using an arbitrary image recognition technique and/or a learned model. For example, the processor 155 can detect the contour shape of the upper surface of each of a plurality of products 10 exposed above, based on images of the products 10 loaded on the pallet 20, captured by the camera 140 from above the products 10. The learned model can be generated, for example, by performing machine learning on a neural network consisting of multiple layers having neurons in each layer, using image data from various images of the plurality of products 10 loaded on the pallet 20 as described above, captured by the camera 140 from above these products 10. As such a neural network, a deep neural network such as a convolutional neural network (CNN: Convolutional Neural Network) having 20 or more layers, for example, may be used. Such machine learning using the deep neural network is referred to as deep learning. Alternatively, the above learned models can be generated using the “Visual Transformer” which is a type of the deep neural network, Transformer based primarily on a self-attention mechanism, and applied to the field of computer vision. The generated learned model is stored in the memory unit 160.

### Operation of Moving Product by Procut Transfer Apparatus 100

Next, a series of processes and operation regarding operation of moving the product by the product transfer apparatus 100 according to the present embodiment will be described mainly with reference to FIG. 7. FIG. 7 is a flow chart showing operation of moving the product by the product transfer apparatus 100.

Firstly, in step S11, the processor 155 of the product transfer apparatus 100 obtains surrounding environment information of the product transfer apparatus 100 by the camera 140 provided on the holder unit 130.

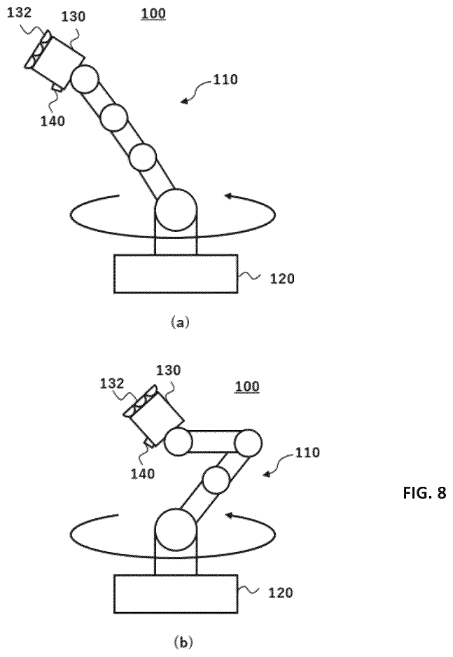

The product transfer apparatus 100 is moved by the AGV 60, and the position layout in the warehouse is changed. The pallet 20 loaded with the products 10 and the cart 30, the belt conveyor 40, etc. which are movement destinations of these products 10 are placed around the product transfer apparatus 100 which has been moved. The processor 155 allows the product transfer apparatus 100 to perform the first operation and the second operation as the operation of obtaining the surrounding environment information of the product transfer apparatus 100 in step S11. FIG. 8 is a view illustrating the first and second operations in step S11 shown in FIG. 7.

In the first operation, as shown in FIG. 8(a), the processor 155 operates the actuators (not shown) of each joint part in a manner that each of the link members 112, 113, 116 of the arm unit 110 of the product transfer apparatus 100 is extended straight out from the base unit 120, and the imaging direction of the camera 140 mounted on the holder unit 130 faces downward toward the front side. Then, the processor 155 rotates the entire arm unit 110 by a predetermined rotation angle (up to one rotation at the maximum) relative to the base unit 120 while capturing images using the camera 140. According to the first operation, the camera 140 positioned at a higher position is used to obtain surrounding environment information in a first range which includes an area relatively far from the product transfer apparatus 100.

In the subsequent second operation, as shown in FIG. 8(b), the processor 155 operates the actuator (not shown) of each joint part in a manner that each of the link members 112, 113, 116 of the arm unit 110 is bent, and the imaging direction of the camera 140 mounted on the holder unit 130 faces downward toward the frontside. Thereafter, the processor 155 rotates the entire arm unit 110 by a predetermined rotation angle (up to one rotation at the maximum) relative to the base unit 120 while capturing images by the camera 140. According to the second operation, the camera 140 positioned at a lower position is used to obtain surrounding environment information in a second range which includes an area relatively close to the product transfer apparatus 100.

In this manner, according to step S11 including the first and second operations described above, the surrounding environment information in the relatively wide first range around the product transfer apparatus 100 can be obtained, and the surrounding environment information for objects in the second range which are relatively close to the product transfer apparatus 100 can be obtained with higher resolution.

While an example of the operations of obtaining the surrounding environment information of the product transfer apparatus 100 including the first and second operations is shown above, only one of the first and second operations (i.e., only one obtaining operation) may be performed as the operation of obtaining the surrounding environment information. Further, the operation of obtaining the surrounding environment information may be performed automatically based on control by the processor 155, or may be performed manually by operating the arm unit 110 and the holder unit 130 by user input operations through the operation unit 172. In the latter case, by focusing the camera 140 around the object for which surrounding environment information should be obtained to obtain the information, it is possible to obtain the information necessary for the operation of the product transfer apparatus 100 with a smaller amount of data in comparison with the case of automatically obtaining information of the entire surrounding area.

Next, in step S12, the processor 155 generates a virtual world (simulation space) which reproduces the surrounding environment of the product transfer apparatus 100 based on the surrounding environment information obtained in step S11 described above, and displays the virtual world on the display unit 174. The virtual world displays each of objects in the real world which is present at least within a range accessible by the product transfer apparatus 100, in addition to the scenery around the product transfer apparatus 100 in the real world (e.g., the floor surface of the logistics warehouse). The object may be a two-dimensional image or a three-dimensional image of an object in the real world obtained by camera 140, or represented by a depth map, or a point cloud, etc. Alternatively, the object may be represented by computer graphics representing the object.

Next, in step S13, the processor 155 assigns annotation information to the objects displayed in the virtual world (simulation space). As described above with reference to FIGS. 5 and 6, the processor 155 assigns the annotation information to the object, based on the selection information (see FIG. 5) of the type of the object as a target to which annotation information is assigned, inputted by the user by operating the operation unit 172, and information about the position, the posture, and the dimensions of the model determined for the object in the virtual world.

The assignment of the annotation information to the object in step S13 is performed for each of the various objects displayed in the virtual world (e.g., the products 10, the pallet 20, the cart 30, the belt conveyor 40, etc.). In particular, in the case where a plurality of products 10 are loaded on the pallet 20, the annotation information may be assigned to each of the products 10 individually. Otherwise, in the case where all of a plurality of products 10 loaded on the pallet 20 have the same size (dimensions of the length, the width, and the height), annotation information (information about the position, the posture, and the dimensions) may be assigned to at least one product 10 on the pallet 20. In the latter case, the same annotation information as the annotation information assigned to the at least one product 10 is assigned to the other products 10 detected using an arbitrary image recognition technique and/or a learned model, by the processor 155.

By this step S13, the processor 155 assigns annotation information, including attribute information and information about the position, the posture, and the dimensions, to various objects through the model Mdl in the coordinate system of the virtual world. By assigning the annotation information to the object in this manner, the processor 155 recognizes that the object in the virtual space displayed on the display unit 174 is not just an object occupying a certain volume space, but represents the object identified by the annotation information assigned to the object, and based on the annotation information assigned in this manner, the processor 155 can calculate and recognize the position, the posture, and the dimensions of the corresponding various objects in the coordinate system of the real world. Stated otherwise, the processor 155 recognizes which types of objects are present around the product transfer apparatus 100 in the real world, in what positions, postures and dimensions, based on the annotation information. The annotation information assigned to each object is at least temporarily stored in the memory unit 160.

Next, in step S14, for each object to be recognized based on the annotation information, the processor 155 determines whether or not the object is present within the range accessible by the holder unit 130 by the arm unit 110 of the product transfer apparatus 100. Information regarding the range accessible by the holder unit 130 by the arm unit 110 of the product transfer apparatus 100 is stored beforehand in the memory unit 160 as known information. The information regarding the accessible range may be plane information around the product transfer apparatus 100 (e.g., circular shape, fan shape, etc.), or may be three-dimensional information (e.g., cylindrical shape, fan-shaped cubic shape, hemispherical shape, etc.) obtained by adding height information to such plane information. Information regarding such an accessible range is determined based on the dimensions and movable ranges of the arm unit 110 and the holder unit 130 of the product transfer apparatus 100.

For each object, the processor 155 determines whether 1) the entire object is present within the accessible range, or 2) at least part of the object is present outside the accessible range, based on the information regarding the accessible range. The determination result is associated with each item of annotation information assigned to each object and stored at least temporarily in the memory unit 160.

Next, in step S15, the processor 155 accepts a first input designating the object (product 10) to be moved by the product transfer apparatus 100 and a second input designating the position or the area on the object which is the movement destination of the product 10.

For example, the first input to designate the object (product 10) to be moved by the product transfer apparatus 100, can be performed by a user who operates the operation unit 172, by performing an input operation to designate the model Mdl corresponding to each of the products 10 displayed in the virtual space. Designation of the model Mdl corresponding to each of the products 10 can be performed, for example, by pointing each model Mdl individually and pressing a predetermined button of the controller to make a decision. Alternatively, designation of the model Mdl corresponding to each of the products 10 can be performed by operation of surrounding a plurality of models Mdl corresponding to a plurality of products 10 by a three-dimensional bounding box.

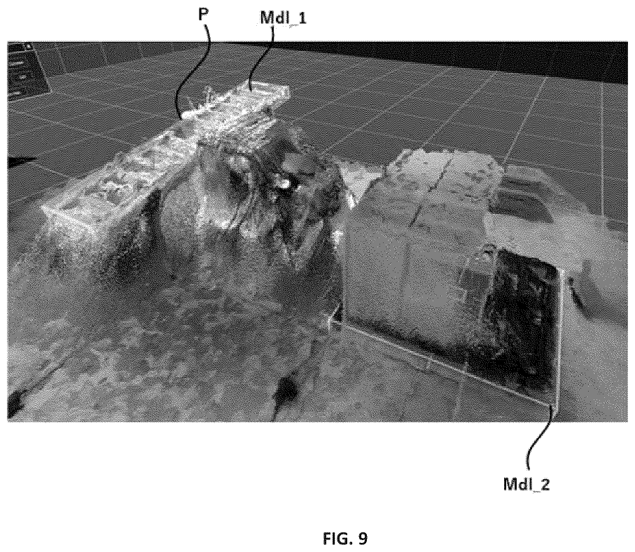

FIG. 9 is a view showing an example of a state where a position or an area on an object at the movement destination of the product is designated. FIG. 9 shows a state where central part of the belt conveyor 40 is designated as the position or the area on the object at the movement destination of the product 10. In FIG. 9, a cubic marker P showing the product movement destination is placed on the central part of a model Mdl_1 indicating the belt conveyor 40. The marker P is placed with inclination along the inclination of the model Mdl_1. This means designation of transportation of the product 10 to a position indicated by the marker P on the belt conveyor 40 in the real world, in the same posture as the marker P. It should be noted that FIG. 9 also shows a model Mdl_2 representing the pallet 20.

Further, the second input to designate a position or an area of the movement destination of the product 10 can be performed, for example, by the user who operates the operation unit 172, by performing an input operation to designate the model Mdl corresponding to the object at the movement destination which is displayed in the virtual space. More specifically, in the case of moving each of the products 10 to a certain position on the belt conveyor 40, designation of the position or the area at the movement destination of the product 10 can be performed by designating a position on the model Mdl corresponding to the belt conveyor 40. In the case of moving each of the products 10 to the area on the pallet 20 or the cart 30, designation of the position or the area at the movement destination of the product 10 can be performed by designating the area on the model Mdl corresponding to the product 10 with a bounding box.

Next, in step S16, based on the first and second inputs above, the processor 155 determines whether or not the designated target object to be moved (the product 10) and each object (the pallet 20, the cart 30, the belt conveyor 40, etc.) related to the position or area on the object at the designated movement destination are present within the accessible range. This determination process can be performed based on the results of the above determination associated with the annotation information assigned to these designated objects. If it is determined that each and every one of these designated objects is entirely within the accessible range (Y), the processor 155 proceeds to the process of step S17 described later.

Otherwise (N), since it may not be possible to safely complete the operation of moving the designated product 10, for the object for which the processor 155 has determined that the object is not entirely within the accessible range, the processor 155 displays a message like this:

“Moving operation cannot be performed because XXX (object) is not within the accessible range. Please move XXX (object) to a position closer to the robot and perform the process from the beginning.”

Then, the processor 155 finishes the process.

Lastly, in step S17, based on the user input accepted in step S15, the processor 155, performs motion planning to operate the product transfer apparatus 100 (in particular, the arm unit 110 and the holder unit 130) to move the designated product 10 to the designated position or area, and the processor 155 generates an operation instruction to operate the product transfer apparatus 100, and operates the product transfer apparatus 100 based on the operation instruction to move the designated product 10 to a position or an area on the designated object. The processor 155 allows the product transfer apparatus 100 to repeatedly perform the Pick and Place operation of the products 10 until all of the designated products 10 have been moved to the designated position or area.

In the operation of moving the products 10 by the product transfer apparatus 100, for example, operation of picking up the product 10 by the holder unit 130 is controlled by the processor 155 by, based on images of a plurality of loaded products 10 captured by the camera 140 from above the products 10, detecting the contour shape of the upper surface of each of the products 10 exposed above, properly aligning the suction cups 132 of the holder unit 130 with the upper surface of each of the products 10 based on the detected contour shape of each product 10, and holding each product 10 by sucking the product 10 with the suction cups 132.

Further, after the operation of picking up the product 10 by the holder unit 130, the processor 155 may perform operation of obtaining the height dimension of the picked up product 10. For example, an additional camera (not shown) having the same function as the camera 140 is installed on the base unit 120 of the product transfer apparatus 100. The processor 155 moves the product 10 once toward the front side of the additional camera after the holder unit 130 picks up the product 10, and performs operation of capturing an image of the product 10 held by the holder unit 130 from the lateral side by the additional camera. Then, the processor 155 applies an arbitrary image recognition technique to the captured image to obtain the height dimension of the product 10. In this manner, it is possible obtain the height dimension of the product 10.

On the other hand, for example, the Pick and Place operation to move the product 10 to a designated position or area is controlled by the processor 155 in a manner that each product 10 is moved repeatedly to a designated position (e.g., central part of the belt conveyor 40 in the example above) and the holding of the product by the suction cups 132 is released repeatedly, and operation of sequentially loading the products on a designated area of the pallet 20 or the cart 30 is performed repeatedly. In particular, the operation of sequentially loading the products 10 on the designated area, as in the latter case is controlled by the processor 155 by, based on the contours of the upper surfaces of the products 10 to be moved, determining the loading position and the posture of the products 10 in a manner that the designated area is filled by these contours, and to sequentially load the products 10 into the designated area according to the loading position and the posture.

It should be noted that the annotation information is assigned to each product 10 as described above, and in particular, the annotation information includes information regarding the height dimension of the product 10. Further, it is also possible to obtain information about the height dimension of each product 10 by the additional camera provided for the product transfer apparatus 100. Based on the height dimension information of the product, at the time of moving the product 10 held by the holder unit 130 to the designated position, operation of the arm unit 110 and the holder unit 130 is controlled by the processor 155 to maintain a distance between the holder unit 130 and the designated position (upper surfaces of the pallet 20, the cart 30, the belt conveyor 40, etc.) greater than the height dimension of the product 10. In this manner, the product 10 held by the holder unit 130 is pressed against the pallet 20, the cart 30, the belt conveyor 40, etc. at the designated position. Thus, it is possible to avoid the situation where the product 10 or the pallet 20, the cart 30, the belt conveyor 40, etc. at the designated positions are damaged.

Further, in particular, in the case of replacing the product 10 onto the other pallet 20 or cart 30, if annotation information is assigned to each product 10 individually as described above, the processor 155 performs motion planning to move these products 10 in a manner that some or all of the space on the pallet 20 or the cart 30 at the movement destination is filled with the volume of the plurality of products 10 to be moved, in consideration of the size of each product 10 (dimensions of the length, the width, and the height), and perform operation of moving the plurality of products 10 by the product transfer apparatus 100. Alternatively, in the case where all the plurality of products 10 to be moved have the same size (dimensions of the length, the width, and the height), based on the annotation information (in particular, information about the position, the posture, and the dimensions) assigned to at least one product 10 as described above, the processor 155 recognizes that each of the products 10 at the movement origin has the same assigned size, and performs motion planning to move these products 10 in a manner that some or all of the space on the pallet 20 or the cart 30 at the movement destination is filled with the volume of the plurality of products 10 to be moved, and allows product transfer apparatus 100 to perform operation of moving the plurality of products 10.

As described above, in the product transfer apparatus 100 of the present embodiment, in the virtual world (simulation space) which reproduces the surrounding environment of the product transfer apparatus 100 in the real world, by assigning annotation information including attribute information and information of the position, the posture, and the dimensions to objects (such as the product 10 to be moved, the pallet 20, the cart 30, and the belt conveyor 40) which are present around the product transfer apparatus 100 in the real world, to the object, it is possible to allow the product transfer apparatus 100 to recognize the attributes and the position, the posture, and the dimensions related to these objects which are present in the real world. Therefore, for example, in the case of operation in a logistics warehouse in which the product transfer apparatus 100 is moved by the AGV 60 as necessary and objects are placed around the product transfer apparatus 100 after the movement to perform operation of moving the product, it is possible to allow the product transfer apparatus 100 to easily and promptly recognize the surrounding environment of the product transfer apparatus 100 after movement.

Further, after receiving a user input designating the product 10 to be moved and a user input designating the position or the area at the movement destination, the product transfer apparatus 100 of the present embodiment is configured to determine whether or not an object related to the operation of moving the designated product 10 is present within the accessible range of the product transfer apparatus 100, and if none of the objects are present within the accessible range,

the product transfer apparatus 100 is configured not to perform the operation of moving the product. Therefore, it is possible to prevent incidents (e.g., damages of the product 10 or other objects due to falling or collapsing of the product 10) which could occur in the case where operation of moving the product is performed when any of the objects is not within the accessible range.

### Modification Example

The above embodiment has been described in connection with the case where if it is determined that the designated object is not within the accessible range of the product transfer apparatus 100 (N) in the process of step S16 shown in FIG. 7, the process is finished without performing the operation of moving the product (step S17). In contrast, the modification example provides means for making it possible to perform operation of moving the product even in the case where it is determined that the designated object is not within the accessible range of the product transfer apparatus 100.

In the modification example, if it is determined that the designated object is not within the accessible range of the product transfer apparatus 100, the object which is determined not to be within the accessible range is moved to a position closer to the product transfer apparatus 100 by the AGV 60. The operation of moving the object by the AGV 60 may be performed by the user manually operating the AGV 60 by remote control, or may be performed by controlling movement of the AGV 60 by the processor 155 of the product transfer apparatus 100 while the product transfer apparatus 100 and the AGV 60 are in communication with each other through the input/output unit 176 of the product transfer apparatus 100.

### First Modification Example

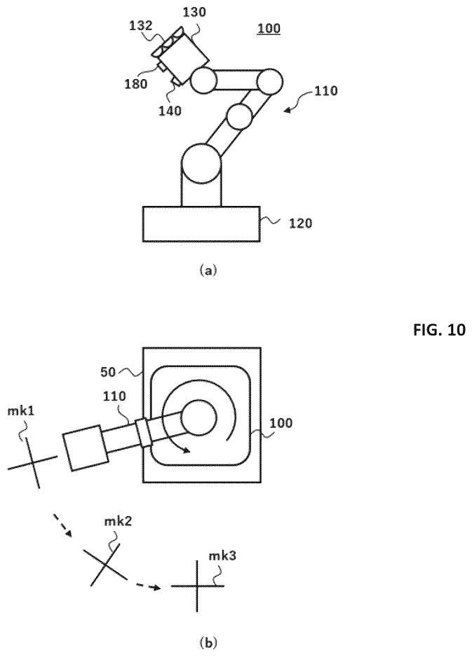

FIG. 10 is a view showing a first modification example of the product transfer apparatus according the present embodiment. As shown in FIG. 10(a), in the product transfer apparatus 100 of the modification example, an indication display section 180 is provided on the holder unit 130 to project an indication display indicating the position of the movement destination of the object, in addition to the structure of the product transfer apparatus 100 described with reference to FIG. 3, etc. For example, the indication display section 180 may be made up of an optical projector which projects an image of the indication display onto a floor surface, etc. on which the product transfer apparatus 100 is placed, or a laser emitter which can draw desired graphic patterns or characters by emitting a laser beam while scanning. The indication display presented by the indication display section 180 may have any shape such as, a cross shape, a circular shape, an arrow shape. In the example shown in FIG. 10, the indication display section 180 is configured to project a cross-shaped indication display.

In the product transfer apparatus 10 of the modification example having the indication display section 180 as described above, the indication display is projected by the indication display section 180 to locations where objects such as the pallet, the cart, the belt conveyor, etc. should be placed. For example, operation of moving the object by the AGV 60 can be performed by the user manually operating the AGV 60 by remote control for moving the object in a manner that the AGV 60 is aligned with the indication display which is projected on the floor surface, etc. Otherwise, in the case where the AVG 60 has an image capture camera and an image recognition apparatus, operation of moving the object may be performed in a manner that the AVG 60 travels autonomously by recognizing the indication display projected on the floor surface, etc., and aligns the position of the indication display with the position of the AVG 60 itself. Alternatively, a worker may manually move the object in a manner that the worker looks at the indication display projected by the indication display section 180 and aligns the object with the indication display.

FIG. 10(b) shows an operation example of projecting an indication display by the product transfer apparatus 100 according to the present modification example. In the product transfer apparatus 100 according to the present modification example, firstly, an indication display mk1 is projected on a location where an object (e.g., a pallet) should be placed, by the indication display section 180, and the pallet is placed at the position of the indication display using the AGV 60, etc. Then, the robot arm 110 is extended, retracted and/or rotated to project the next indication display mk2 by the indication display section 180 at a location where the next object (e.g., cart) should be placed, and the cart is placed at the position of the indication display using the AGV 60, etc. As described above, the product transfer apparatus 100 in the present modification example repeatedly performs the operation of displaying an indication display by the indication display section 180 at the location where the object should be placed. It should be noted that, for example, the position at which the indication display is projected by the indication display section 180 can be designated by the user using the input/output unit 176 of the control device 150 within the virtual world (simulation space) in which the control device 150 reproduces the surrounding environment of the product transfer apparatus 100 in the real world.

After the AVG 60 moves the object to a position closer to the product transfer apparatus 100, the processor 155 performs the process described with reference to FIG. 7 from the first step S11 again. In this manner, the surrounding environment information including the moved objects (the pallet 20, the cart 30, the belt conveyor 40, etc.) is obtained again (step S11), the object moved within the virtual world is reproduced (step S12), the annotation information is assigned to the moved object (step S13), for at least the moved object, a determination is made as to whether or not the object is present within the accessible range (step S14), and a designation input is made for at least the moved object (step S15).

Then, as a result of the subsequent determination regarding whether or not the designated object is present within the accessible range of the product transfer apparatus 100 (step S16), if it is determined that the designated object is present within the accessible range, operation of moving the product 10 is performed (step S17). If it is determined again that the designated object is not within the accessible range of the product transfer apparatus 100, the object is moved again by the AGV 60 and the processes of the above steps S11 to S16 are repeated until it is determined that the designated object is present within the accessible range.

As described above, according to the modification example, if it is determined that the designated object is not within the accessible range of the product transfer apparatus 100, operation of moving the object by the AGV 60 is repeated until the object is positioned within the accessible range, and eventually, it becomes possible to perform operation of moving the product.

### Second Modification Example

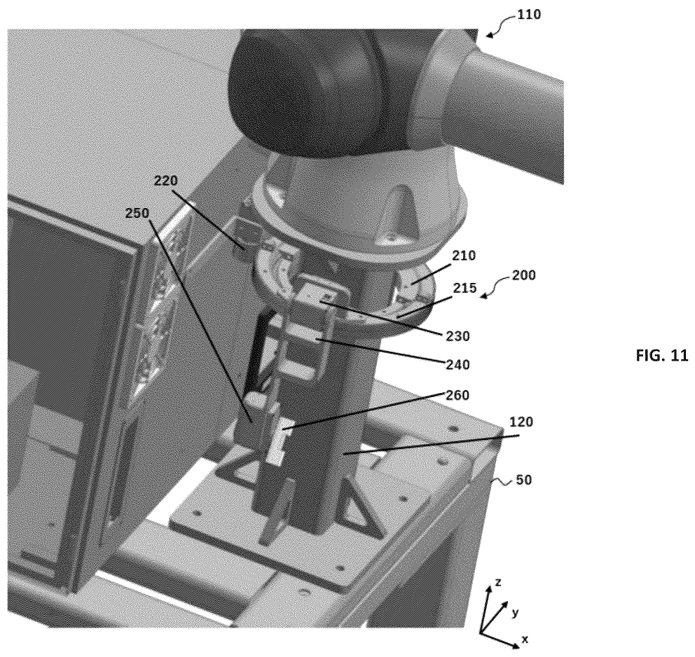

Next, a second modification example of the product transfer apparatus in the present embodiment will be described with reference to FIG. 11. As shown in FIG. 11, in the second modification example, instead of the indication display section 180 provided on the holder unit 130 of the first modification example, an indication display unit 200 is provided on the base unit 120 fixedly supporting the arm unit 110 of the product transfer apparatus 100. In the example, the base unit 120 is fixed on the placement table 50.

The indication display unit 200 has an annular fixing section 210 fixed to the base unit 120 to surround the periphery of the columnar base unit 120, an annular rotation section 215 supported rotatably by the annular fixing section 210 along the circumference of the annular fixing section 210, and a rotary drive source 220 which rotates the annular rotation section 215.

A plurality of ball bearings (not shown) are sealed between the outer circumferential surface of the annular fixing section 210 and the inner circumferential surface of the annular rotation section 215, and the annular rotation section 215 is supported by the annular fixing section 210 in a manner that the annular rotation section 215 can rotate in the circumferential direction of the annular fixing section 210 but does not move in the axial direction of the annular fixing section 210 (in the z-direction in the figure). Further, a gear (teeth) is formed on the outer circumferential surface of the annular rotation section 215.

The rotary drive source 220 has a gear having a toothed outer surface and a motor which rotates the gear. The teeth of the gear of the rotary drive source 220 are meshed with the teeth formed on the outer circumferential surface of the annular rotation section 215, and the gear of the rotary drive source 220 can rotate the annular rotation section 215 by driving rotation of the gear of the rotary drive source 220. By switching the direction of rotation of the motor of the rotary drive source 220, the direction of rotation of the annular rotation section 215 can be switched.

The indication display unit 200 further includes a first drive section 230 provided on the annular rotation section 215, a rod section 240 having a root end supported by the first drive section 230, a second drive section 250 provided at a distal end of the rod section 240, and an indication display section 260 supported by the second drive section 250.

For example, the first drive section 230 is made up of a servo motor, and the rod section 240 supported by the first drive section 230 can be rotated about the root side of the rod section 240 as a rotation center. For example, the rod section 240 can be rotated in a direction in which the front end of the rod section 240 is lifted upward from the state in which the front end of the rod section 240 is oriented downward, as shown in FIG. 11. Further, for example, the second drive section 250 is also made up of a servo motor, and it is possible to rotate the indication display section 260. The indication display section 260 may also be made up of an optical projector which projects an image of the indication display onto a floor surface, etc. on which the product transfer apparatus 100 is placed, or a laser emitter which can draw desired graphic patterns or characters by emitting a laser beam while scanning.

As described above, the indication display unit 200 in the modification example can change the position and the orientation of the indication display section 260 relative to the base unit 120 through three degrees of freedom: rotation by the annular rotation section 215 (first degree of freedom), rotation by the first drive section 230 (second degree of freedom), and rotation by the second drive section 250 (third degree of freedom). Therefore, in the indication display unit 200 of the modification example, the position and the orientation of the indication display section 260 can be changed as necessary by driving the respective drive sections. By doing so, it is possible to project the indication display from the indication display section 260 to the location where objects such as a pallet, a cart, a belt conveyor, etc., should be placed around the product transfer apparatus 100. Since the indication display unit 200 of the present modification example is provided independently from the arm unit 110 of the product transfer apparatus 100, unlike the case of the first modification example having structure where the indication display section 180 is provided on the holder unit 130 at the front end of the arm unit 110, it is possible to project the indication display by the indication display section 260 independently from operation of the arm unit 110 advantageously.

While the present invention has been described though embodiments of the invention, the embodiments are not intended to limit the scope of the invention as claimed. Further, any form of combination of the features described in the embodiments of the present invention may also be included in the technical scope of the invention. Furthermore, it is also apparent to those skilled in the art that various modifications or improvements can be made to the embodiments described above.

1. A product transfer apparatus configured to move a product,
the product transfer apparatus comprising:
an arm unit having a holder unit configured to hold the product;
an acquisition unit configured to obtain surrounding environment information of the product transfer apparatus; and
a control unit configured to control operation of the holder unit, the arm unit, and the acquisition unit,
wherein the control unit is configured to perform:
allowing the acquisition unit to obtain surrounding environment information of the product transfer apparatus in a real world,
generating a virtual world including an object present around the product transfer apparatus in the real world, based on the surrounding environment information,
in the virtual world, assigning annotation information including attribute information of the object and information regarding a position, a posture, and a dimension of the object, to the object,
accepting a first input designating a product to be moved, and a second input designating a position or an area of a movement destination of the product, for the object present in the virtual world, and
in the real world, allowing the holder unit and the arm unit to perform operation of moving the designated product to the designated position or the designated area, based on the first input and the second input.

2. The product transfer apparatus according to claim 1, wherein the assigning the annotation information to the object includes:
in the virtual world, accepting a selection of the attribute information of the object as a target for which the position, the posture, and the dimension are designated,
in the virtual world, displaying a model for designating the position, the posture, and the dimension of the object, and obtaining information regarding the position, the posture, and the dimension of the model overlapped in alignment with a contour of the object, and
assigning the accepted attribute information and information regarding the obtained position, posture, and dimension of the model as the annotation information, to the object.

3. The product transfer apparatus according to claim 2, wherein the obtaining information regarding the position, the posture, and the dimension of the model overlapped in alignment with the contour of the object includes accepting an input for changing the position, the posture, and the dimension of the model in alignment with the contour of the object in the virtual world.

4. The product transfer apparatus according to claim 2, wherein the accepting the selection of the attribute information of the object includes:
displaying a screen showing an option regarding the attribute information of the object in the virtual world, and
in the virtual world, accepting an input selecting the attribute information of the object.

5. The product transfer apparatus according to claim 1, wherein the control unit is configured to further perform determining whether or not the object designated in the first input and the second input is present within an accessible range of the product transfer apparatus; and
wherein the allowing the holder unit and the arm unit to perform operation of moving the designated product to the designated position or the designated area is performed in the case where the designated object is present within the accessible range.

6. A method of controlling a product transfer apparatus configured to move a product,
the product transfer apparatus comprising:
an arm unit having a holder unit configured to hold the product;
an acquisition unit configured to obtain surrounding environment information of the product transfer apparatus; and
a control unit configured to control operation of the holder unit, the arm unit, and the acquisition unit,
wherein the method is performed by the control unit and including:
allowing the acquisition unit to obtain surrounding environment information of the product transfer apparatus in a real world, generating a virtual world including an object present around the product transfer apparatus in the real world, based on the surrounding environment information,
in the virtual world, assigning annotation information including attribute information of the object and information regarding a position, a posture and a dimension of the object, to the object,
accepting a first input designating a product to be moved, and a second input designating a position or an area of a movement destination of the product, for the object present in the virtual world, and
in the real world, allowing the holder unit and the arm unit to perform operation of moving the designated product to the designated position or the designated area, based on the first input and the second input.

7. A non-transitory computer-readable storage medium storing a computer program for controlling a product transfer apparatus configured to move a product, wherein the product transfer apparatus comprising:
an arm unit having a holder unit configured to hold the product;
an acquisition unit configured to obtain surrounding environment information of the product transfer apparatus; and
a control unit configured to control operation of the holder unit, the arm unit, and the acquisition unit,
wherein the program allows the control unit to perform:
allowing the acquisition unit to obtain surrounding environment information of the product transfer apparatus in a real world, generating a virtual world including an object present around the product transfer apparatus in the real world, based on the surrounding environment information,
in the virtual world, assigning annotation information including attribute information of the object and information regarding a position, a posture and a dimension of the object, to the object,
accepting a first input designating a product to be moved, and a second input designating a position or an area of a movement destination of the product, for the object present in the virtual world, and
in the real world, allowing the holder unit and the arm unit to perform operation of moving the designated product to the designated position or the designated area, based on the first input and the second input.
